(19) United States
(12) Patent Application Publication
(10) Pub. No.: US 2010/0293947 A1
(43) Pub. Date: Nov. 25, 2010

(54) Nuclear Reactor

(76) Inventor: Jiubin Chen, Shandong (CN)

Correspondence Address: GLOBAL IP SERVICES, 7285 W. Eagle Court, Winton, CA, 95388, US

(21) Appl. No.: 12/602,565

(22) PCT Filed: Apr. 14, 2008
(86) PCT No.: PCT/CN2008/000757

§ 371 Date: Dec. 1, 2009

(30) Foreign Application Priority Data
Apr. 18, 2007 (CN) 200710014342.9
May 21, 2007 (CN) 200710015613.2
Oct. 25, 2007 (CN) 200710113518.6
Nov. 28, 2007 (CN) 200710114685.2
Dec. 4, 2007 (CN) 200710114857.6
Dec. 7, 2007 (CN) 200710116117.6
Dec. 15, 2007 (CN) 200710115993.7
Dec. 19, 2007 (CN) 200710115749.0
Jan. 18, 2008 (CN) 200810008421.3

(51) Int. Cl. G21D 5/00

(52) U.S. Cl. 60/644.1

(57) ABSTRACT

This invention publishes a kind of nuclear reactor, including shell body, lighter system, starting system and fuel system, the shell body is installed magnetic force bearing axle, which is installed flywheel axle, which is installed flywheel, which is installed gas-mixed room, and there is air inlet in the middle of gas-mixed room, cylinder installed on the outside of flywheel. There is an air outlet on the outside of the air-mixed room, air inlets on cylinder bottom, the air outlets and inlets are interconnected. There are lighters equipped in cylinder, which's spraying direction and flywheel semi diameter form the included angle Φ1. it adopts the new manner of nuclear reaction, which can realize every kind of nuclear reaction, realize the nuclear fusion and realize the reaction of ganta into energy, safe and reliable and without any nuclear. It can use any kind of element as the fuel which can produce variable kinds of elements and new materials, the nuclear energy can transferred into kinetic energy and heat energy directly.

### FIELD OF THE INVENTION

This invention involves in nuclear equipment field, which is a kind of nuclear reactor.

### BACKGROUND OF THE INVENTION

The following problems exist in the recent nuclear reaction manner, whose are: the nuclear fusion reaction can not be controlled and used by the human, which is only used for destructive weapon, and is only a dream for using the nuclear fusion energy. Some other manners seem to be available in theory, but never come true in practical. There is nuclear fuel existing in nuclear fission reaction which is only using heavy elements, with the features of serious radiocontamination, difficulty in dealing with the nuclear waste and nuclear safety problem, complex nuclear equipment, high cost, complex technology, tight nuclear material, high material cost, high equipment operating and maintenance cost.

Anyway, it is just a start for knowing, realizing and using the nuclear reaction and have no complete acknowledge for atomic structure and to the nuclear reaction. The recent nuclear reactors are all nuclear fusion reactors, with the features of only using heavy elements, with serious radiocontamination, difficult in dealing with the nuclear waste and nuclear safety problem, complex nuclear equipment, high cost, complex technology, tight nuclear material, high material cost, high equipment operating and maintenance cost. The nuclear fusion reactor equipment is still in trial stage, which is still unknown for the trial result.

### SUMMARY OF THE INVENTION

The purpose is to offer a kind of nuclear reactor, which uses a new nuclear reaction manner, easy operated and can realize variable kinds of nuclear reaction, with the features of safety, without any radiocontamination, and also can use any kind of elements as the nuclear fuel, even use the air to be the nuclear fuel, which can produce variable kinds of elements, including variable elements and singularity elements to produce many kinds of new materials. The nuclear energy can be transferred into kinetic energy and heat energy directly, safe, easy operated and simple equipment structured. And the fuel will be found everywhere, which will solve the problem of energy and resource thoroughly.

The nuclear reaction manner stated in this invention: first use the increasing vortex flow from the center to the surrounding in order to make the fuel and air inhaled into backset from the backset center automatically, and to make the fuel and air mixed averagely during the motion process from backset center to periphery.

And also make the mixed pressure increased Simultaneously, under the affection of circle motion centrifugal force, it will enter into the decreasing backset from the center to the surrounding to been burnt, then the backset will make the fuel and air further mixed and make the fuel burnt in backset center, and also form a high-temperature and high-pressured environment in the backset center, so that the fuel can burnt much more completely.

At the same time, the high temperature and high pressure environment can produce high pressure air. using the high pressure air can form a decreasing helix-promotion spraying air current from the center to surrounding with a certain direction and angle, which owns quicker spraying speed and thrust, with the thrust can further promote the circle motion and quicken the circle motion, so as to the increasing rev of backset more quicker from the center to periphery.

And also make the substance molecule from the backset center into backset worked on a great rotating acceleration from the backset, make the affection of rotating acceleration speed molecule more and more on the molecule motion from backset center into backset current, and make the molecule separated into atom, atom formed into plasma state.

By the centrifugal force and inertia impact, the moving plasma is made entered into the rev-decreasing backset center from the center to periphery. The atom structure of plasma was cut and destroyed by the torsion force under the high temperature affection produced by fuel burnt in the backset and also make the atom nuclear reaction and release energy.

The energy released by atom will transfer into stronger thrust, and also push circle motion further, quicken the circle motion, strengthen the nuclear reaction, which can make the atom of every elements take place the nuclear reaction, finally it can realize the nuclear fusion reaction of hydrogen atom, even the reaction of guanta into energy.

The circle motion pushed by thrust of spraying current will make nuclear reaction energy transferred into the torsion force, and change the spraying current angle so as to produce a decreasing screw-pushed spraying current from the center to surrounding along the rotating axle direction of circle motion, and also make the nuclear reaction energy transferred into the thrust and torsion force of kinetic energy by the thrust of spraying current and torsion force of circle motion.

The rev decreasing backset from the center to surrounding makes the nuclear reaction energy centralized in the backset center, and also make the backset center produce the super high temperature and high pressure environment, and also use this environment to produce variable kinds of elements and materials, by the high temperature makes the nuclear reaction energy transferred into heat energy directly.

As the feature of the circle semidiameter longer, the circle perimeter will be also longer, when every points in the circle rotate around the center with the same rotating speed, the point far from the center has the higher circle motion speed, also under the affection of centrifugal force, it will make the motion from the center to circle surrounding forming parabola motion with increasing speed.

During the motion process of the air from the circle center under the affection of centrifugal force, a rev decreasing backset cyclone is formed by the affection of inter-attrition among the gas particle and the motion increasing speed, which can produce a force outside of the backset with increasing speed, and also the force can increase the air pressure outside the backset, quicken the air current moving speed, and make every particle in the backset relatively move, consequently the fuel and gas will mix together symmetrically.

The backset cyclone can produce a speed-up force flowing into the cyclone periphery, which can increase the air pressure in the backset periphery, make the air flow with a higher movement speed, and this backset can make every particle in the backset moved relatively as well, so that the gas and fuel can be mixed together completely.

When the dots in the circle are doing circular motion, and the resistance from the circle center to the circular periphery is increasing, the gas in the circular motion fields will become a vortex flow whirl which is decreasing from the circle center to the circular periphery, what's more, the air flow needs to make propulsive movements along the circular motion's rotation axis to help the formation and the maintaining of the backset flow air whirl, which is familiar to the water's backset movements and the tornado's air flow movements. The propulsive movement has a faster propulsive speed, and the speed is decreasing from the center to the periphery, which means a cone-shaped frontal surface is formed and the air flow has a higher propulsive speed and power. This vortex air flow cyclone can make the new coming fuel mixture gas automatically into the vortex center, and heat will come out when the fuel combustion is burning in the vortex center, moreover the heat will pass out and its pass out speed has a deceleration which is caused by the energy loss during the energy transmission. In that case, a deceleration will come out in the course of heat transmission from the vortex center to the vortex periphery, which accordingly enhance the rev in the vortex center, making the energy centralizing in the vortex center, what's more, a higher temperature and pressure will appear in the vortex center, and a lower one in the vortex air cyclone in the periphery.

Each point in the vortex cyclone has a relative movement and vortex air flow has a cutting and detaching power against the vortex air cyclone. The realization of this invention is just using this principle and the nuclear reaction method. If we impose a huge atomic spin torque to the atoms, it will disrupt the balance of their own fields, making the atoms into a plasma state, moreover under the force of cutting and detaching even the high temperature and high pressure, the plasma will take place the nuclear reaction. In this method, the temperature and the pressure that nuclear reaction needs will be greatly reduced, and the conditions of nuclear fusion reaction will be easily realized. A higher rev will realize the formation of the hydrogen atoms' nuclear fission reaction; in fact, the hydrogen atoms' nuclear fission reaction is easier to the fission reaction. It will easier to realize the nuclear reaction if we have reached the following: high temperature and high pressure, imposing a huge acceleration of the atomic spin speed, high speed collision, cutting and detaching.

The declared nuclear reactor of this invention can succeed a variety of nuclear reactions; it can make the hydrogen atoms' fission reaction come true. What's more, it has a wide use range, such as it can be directly used as engine, and thermal equipments. It has many advantages such as: simple structure, light weight, low cost, low maintenance cost, and long service life. moreover, when it is used as a engine, it also has many advantages such as high rev, high jet speed, high inject speed, completely free fuels and it can also use a variety of elements in the air as the fuel. As the thermal device, it can produce a variety of elements such as gold, other precious and rare elements, etc. Using the garbage to produce gold, it is really spin gold from straw; it can also produce many unknown elements and a lot of materials, which are not be produced by existing technology. It also can use the conventional fuels as conventional motive power to produce electricity, heat and other driving force. It can be used in all fields to replace all existing types of nuclear reactors. When we using the conventional fuels, it can more directly transfer the heat energy into dynamic energy, reducing the energy loss of the extra links, at the same time, its fuels will burn more fully, so the emission will be more environmentally, more energy will be saved and its energy using rate will be up to 90%. It can also use the nuclear fuel without nuclear contamination and realize the nuclear energy's extensive use, making the energy resources becoming extremely cheap and inexhaustible. It can make all kinds of the elements in the air occur nuclear reactions, what's more, the nuclear fuel field is very broad, we can use any element as the nuclear fuel. As the nuclear reactor, we can use it to deal with the rubbish; what's more, it can be used to synthetic elements, just like the precious gold and rare elements to completely solve the resources and energy problems.

For realizing the above purposes, we can operate the following technology scheme: nuclear reactor has the shell body, lighting system, starting system and fuel system, equip magnetic bearing on the shell body, equip flywheel axis on the magnetic bearing, equip flywheel on the flywheel axis, equip air-mixed room on the flywheel, open air inlet on the air-mixed room, install cylinder on the flywheel periphery, open air outlet on the air-mixed room periphery, open an air inlet on the cylinder bottom, connect the air inlet and air outlet, install lighter in the cylinder, the angle between the cylinder spraying direction and flywheel semidiameter is Φ1, there is air intake pipe in the air inlet, intake pipe end is the same direction with the flywheel rotating direction, the another pipe end has the same direction with the cylinder lumen section tangent direction. There are burning room and spraying room equipped in the cylinder. The burning room outlet part sectional area is smaller than the air inlet area, the spraying room inlet part sectional area small than the max burning room sectional area; the spraying room lumen extends to the flywheel along the hatch. The cylinder lumen central axis is curve line. Open upper air inlet on the upper wall of the cylinder bottom, open lower air outlet on the lower wall of the air-mixed room periphery; connect the upper air-inlet and lower air-outlet through. Open lower air inlet on the lower wall of the cylinder bottom, open upper air outlet on the lower wall on the upper wall of the air-mixed room periphery. Connect the lower air inlet and upper air outlet through. Open upper air inlet on the upper wall of the cylinder bottom, open upper air outlet on the lower wall of the cylinder bottom, open the upper air inlet on the upper wall of the air-mixed room periphery, and connect the two holes through. Open side air outlet of the air-mixed room side, open side air-inlet on the cylinder bottom side; connect the two side holes through. Install air-mixed room and cylinder on the upper and lower sides of the flywheel individually. The cylinder is the thrust cylinder, whose spraying direction and the flywheel plane perpendicular to the flywheel axis plane form the angle Φ2. Equip air-intake controlling equipment in the shell body, which is corresponding with the air intake hole.

The advantages of this invention are: adopt new nuclear reactor method, easy operated; also can realize variable kinds of nuclear reaction and nuclear fusion reaction; be able to realize the reaction of guanta into energy; safe and reliable, without any nuclear pollution; can use any kind of element as the nuclear fuel; can use air as nuclear fuel directly, solve the energy and resource crisis thoroughly; can produce any kinds of elements, including variable kinds of precious elements and rare elements; can produce many kinds of new materials; the nuclear energy can be transformed into energy and heat directly. This invention has features of simply structure, safe and reliable, low fuel cost, etc.

### BRIEF DESCRIPTION OF THE DRAWINGS

Drawing 1 is the main sketch map for structure in this invention operating example;

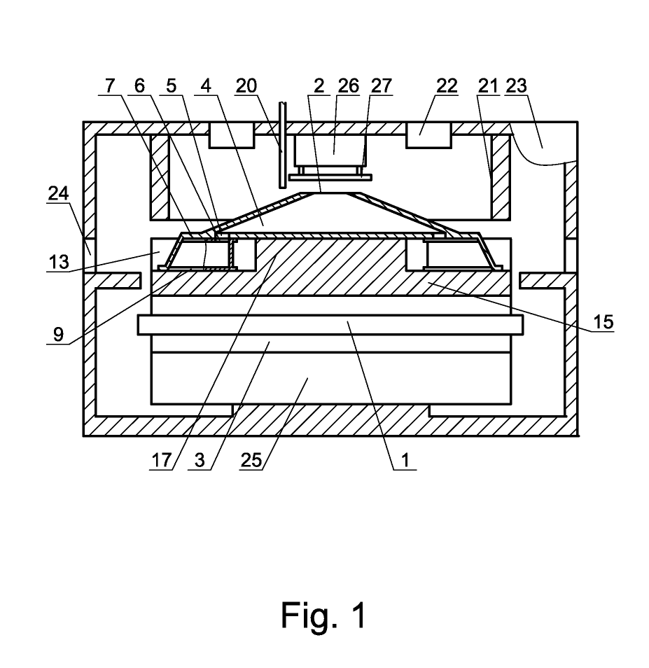

Drawing 2 is the plan form of FIG. 1;

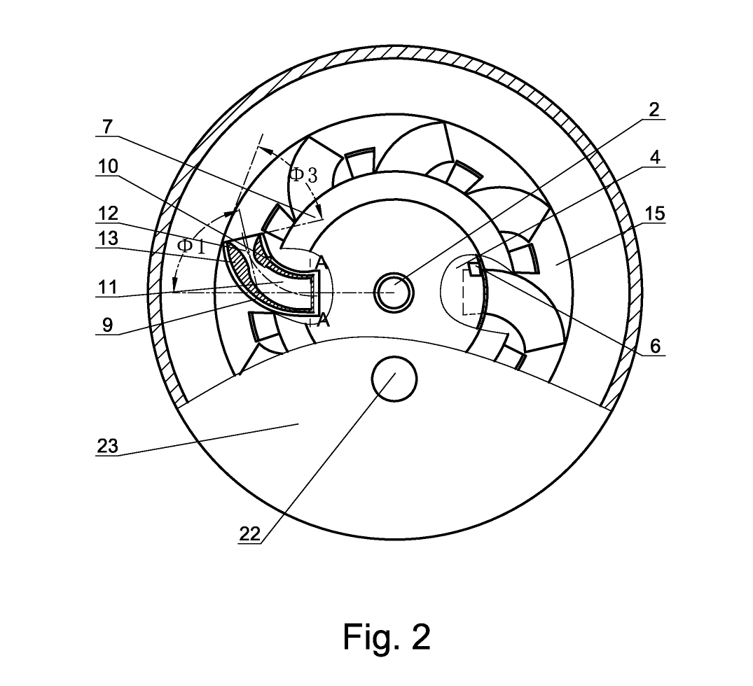

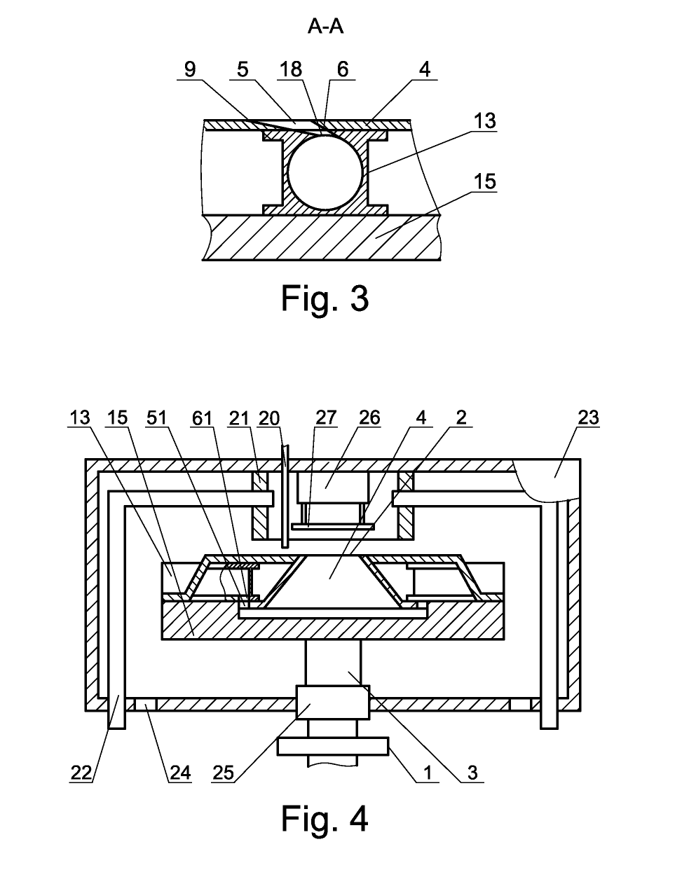

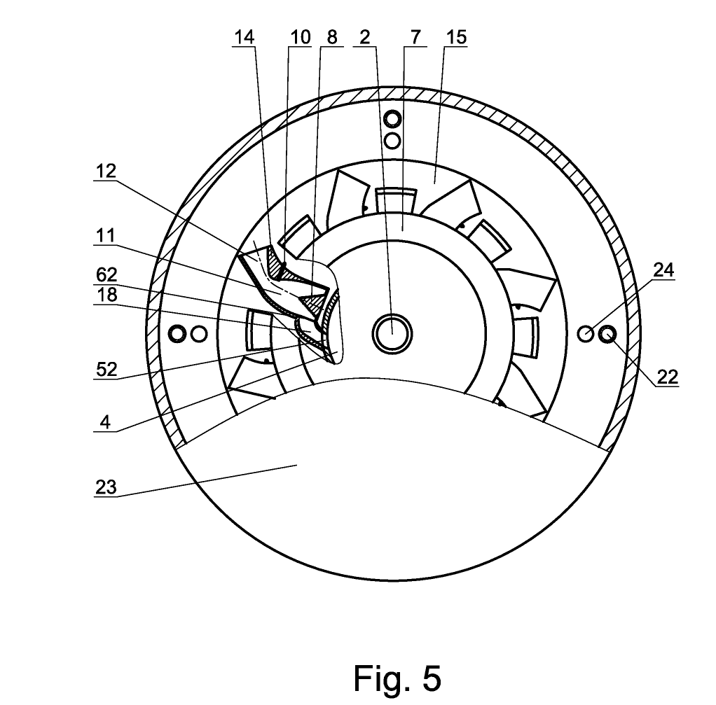

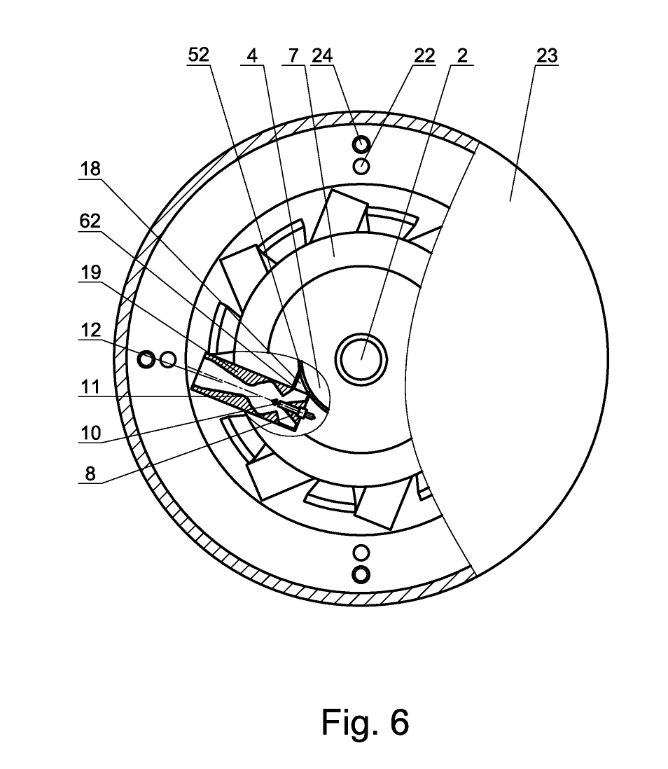

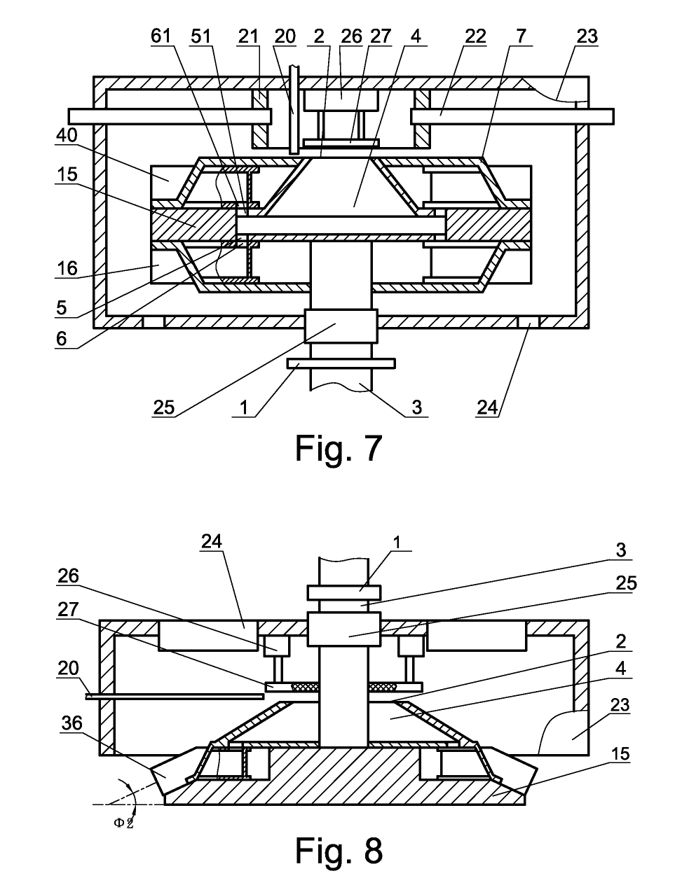

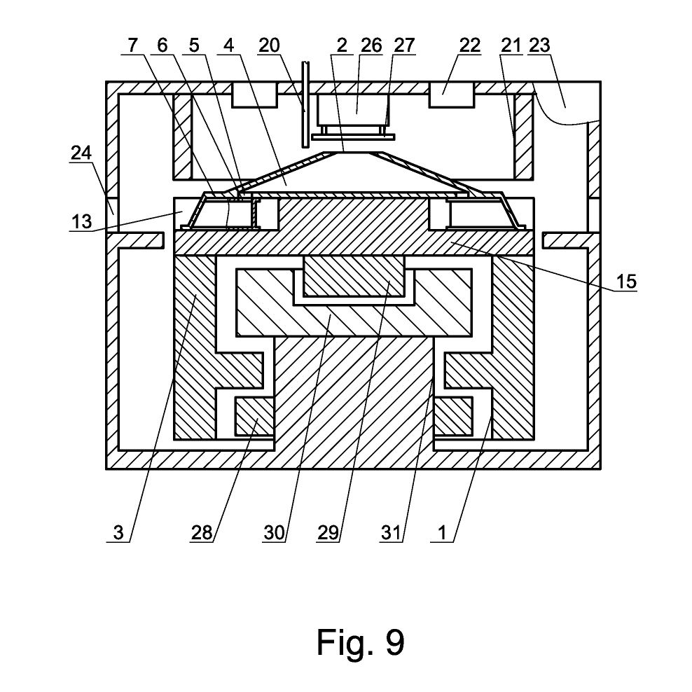

Drawing 3 is the magnifying structure sketch map for A-A section in FIG. 2;

Drawing 4 is the sketch map for main structure in the second invention operating example;

Drawing 5 is the plan form structure sketch map for the third operating example;

Drawing 6 is the plan form structure sketch map for the forth operating example;

Drawing 7 is the main structure sketch map for the two-faced cylinder structure nuclear reactor;

Drawing 8 is the mail structure sketch map for the nuclear reactor realizing thrust exporting.

Drawing 9 is the main structure sketch map for structure-nuclear reactor and generator produced into one body.

### DETAIL DESCRIPTION OF THE INVENTION

The main structure of this invention is: the nuclear reactor includes shell body 23, lighting system, starting system and fuel system. The shell body 23 is also the nuclear reactor's frame and base. When nuclear reactor is used as the thermal equipment, the shell body 23 can be made into storage bin or use the storage bin instead of shell body 23 directly. On the shell body 23 can add a layer of thermal insulation to reduce the energy loss and can eliminate the noisy, in the shell body 23 can equip a supporting frame to stabilize the inner structure. Also equip many accessorizing equipments of the nuclear reactor on the shell body 23. Leave a checking hole on the shell body 23, sealing it when it is not used. Use the shell body 23 to eliminate the noisy and shield the nuclear radiation etc, and also use the shell body 23 to collect heat to make the nuclear reactor export the heat energy.

There is air outlet 24 on the shell body 23, magnetic force bearing axle 25 is also equipped on 23, and flywheel axle 3 is installed on magnetic bearing axle 25. Because only through the high-speed rotating the nuclear reactor can realize the nuclear reaction, the bearing axle of this invention should be able to bear the high speed rotation, which usually adapts magnetic force bearing axle 25.

Magnetic bearing axle 25 is with many structures, while the nuclear reactor can adopt a kind of simple magnetic bearing axle 25, which is composed of inside and outside permanent magnet with slower rev relatively. There is flywheel 3 installed on Magnetic bearing axle 25 which can realize the high speed rotating.

Magnetic bearing axle can be made with big diameter; even can be bigger than the flywheel's 15, which can improve its rev bearing ability, whose exact dimension can be made according to the actual need. The flywheel 3 can adopt hollow axle, whose diameter can be equal or a little bigger than the flywheel's 15. Then by this flywheel's 3 bearing ability will be improved definitely. Also can produce the magnetic bearing axle 25 and the flywheel 15 together directly, then the magnetic bearing axle can play the role of flywheel axle 3 and flywheel 15 at the same time. Magnetic bearing axle 25, flywheel axle 3 and flywheel 15 also can be produced together which is fit for power generation. The outer magnet of the magnetic bearing axle 25 can also be as the power-generating magnetic field of the generator. The magnetic bearing axle's 25 rev bearing ability decides the rev speed of the nuclear reactor and also the strength of the nuclear reaction, the rev speed also can decide the elements and particle reacting accordingly.

The magnetic bearing axle 25 mentioned here is by permanent magnet and electronic magnet which are strengthening along with the rev increasing, and can quicken the rotating speed largely. It is composed of both the inner and outer permanent magnet, electric magnet and electric magnet cooling system together.

There are power generators in both the inner and outer electric magnet and electric magnet cooling system, and the outer generator system can be as the starting equipment of the nuclear reactor synchronously.

After outage, the magnetic field between the two permanent magnets can make the outer and inner magnet of the magnetic bearing axle 25 never touch with each other, preventing the inter-damage by touching. The inner and outer permanent magnets can be designed into two ring structures which are set together. Every electric magnet can be equipped with a power generating circle and a set of cooling system, only if the nuclear reactor rotating, it will make the power generator circle generating, the electric current can also make the electric magnet and its cooling system work automatically. The nuclear reactor rev speed higher, the electric current bigger, the magnet field of every electric magnet stronger, the power of the cooling system will be bigger accordingly.

The electric magnet cooling system can be equipped on the flywheel axle 3, which can be cooled by liquid hydrogen and increase the electric conductivity ability of the electric magnet circle, making the magnetic field of electric magnet stronger and increasing the rev index of magnet bearing axle 25. The magnetic force bearing axle 25 also can adopt the current magnetic bearing axle.

Power generation circle system can be starter and also the power generator at the same time; we can equip the barrel-shaped permanent magnet on the flywheel 3 as the magnetic filed prosperity of the generator and starter. Two circuits outside of the circle: one for exporting the electric energy, another as the starting circuit, in which is installed on equipment for transferring current direction and make the starter working. Set a barrel-shaped permanent magnet on the circle, in which we also set an electric magnet power generator circle of the magnetic bearing axle. This power generator circle rotates synchronously with the flywheel 15, only if the flywheel rotates, the circle can generate power automatically to make the electric magnet of the magnetic force bearing axle form magnetic filed and also make the cooling system working automatically.

Nuclear reactor can also adopt a kind of simple magnetic force bearing axle 25, which is composed of both the inner super-permanent magnet and outer super-permanent magnet. Equipped in permanent magnet which is connected with the flywheel axle 3, the electric magnet has a special circuit and also a set of cooling system, which can also cancel the cooling system, only if the flywheel 15 rotates the electric magnet, the strong magnetic field will be produced. When the flywheel 15 rotation stops, the electricity will cut off. After outage, the magnetic field between the two super-permanent magnets will make the outer and inner magnet of the electric magnetic bearing axle unconnected, avoiding the inter-damage.

Flywheel axle 2 is equipped with flywheel 15, which is installed air mixed room 4 and there is air inlet 2 in the middle of air mixed room 4. In the shell body 23 there is air pipe, whose exit is located in the flywheel 15 edge, and also no need to use the air pipe 22, air inlet holes can be opened on the shell body 23 directly.

We can also adopt the other air-supplying manners, for example, we can make the flywheel axle 3 as the hollow axle, in which we can set the gas pipe line and supply gas to the air-mixed room 4, this kind of air supplying manner will be affect the whole structure which is not usually adopted. There are many kinds of fuel system structures, the most common-used manner is to equip the fuel pipe 20 on the shell body 23, and the end of fuel pipe 20 is near the air inlet 2.

For the liquid fuel, on the fuel pipe outlet 20 can add an Atomization nozzle, and use the fuel pump to press and transport the fuel; while for the gas fuel, air outlet can be equipped on the fuel pipe 20 directly, then the fuel can be transported automatically by itself; while for the solid fuel, it can be transported by the current and also can equip a funnel-shaped fuel outlet on the air inlet 2.

Controlling the fuel flow can realize the adjustment on the rev and power, which can be equipped with a controller connected with a throttle controller to realize the control. The fuel system can transport the fuel through the flywheel axle 3, which can be made as the hollow axle. In the hollow axle, fuel pipe is equipped and used to supply fuel into the air-mixed room 4, however, this kind of structure is easy to affect the overall performance, which is not usually adopted.

The common usage for fuel system is for lighting, after the nuclear reaction finished, the fuel supplying will be shut down, and the nuclear reactor can make every kind of element in the air to be the nuclear fuel. For preventing the exhaust gas into the nuclear reactor, we can equip a shield on the shell body 23 which should be inside the flywheel edge 15, mustn't touch the flywheel 15. On the air-mixed room 4 can open an air outlet, and the room's air outlet's diameter should be smaller than the air outlet's.

The central axis of the air-mixed room 4 and the flywheel central axis are on the same line, the air inlet 2 center and the flywheel 15 central axis are also on the same line. The center area of the air-mixed room 4 lumen is thicker; the edge area is thinner, which will future increase the air pressure on the air-mixed room 4 edge. Air-mixed pressure and flywheel 15 can be made into one body together and also can be separated. We can design the flywheel 15 to be hollow and use the hollow area as the air mixed room 4.

Install cylinder on the flywheel 15 periphery, in order to use space to increase energy as much as possible. On the flywheel 15 periphery can equip as many cylinders as possible. Seal the cylinder bottom, the cylinder lumen section is round, open the air inlet on the cylinder bottom, connect the air inlet and the outlet of the air-mixed room 4. equip an air inlet pipe 18 in the air inlet, one end of the air intake pipe 18 directs to the flywheel 15 rotating direction and extends to the air-mixed room 4 synchronously, another end of the air intake pipe 18 directs to the section tangent direction of the cylinder lumen, equip burning room 11 and spraying room 12 in the cylinder. The air inlet section diameter of the spraying room 12 is smaller than the burning room 11 section diameter, the angle Φ1 is formed between the spraying direction of the spraying room 12, which is not zero and should be better in the range of 55.62°-68.76°. There is shrunken spraying hole between the burning room 11 and the spraying room 12, the spraying room hole extends, and the inside diameter of the spraying room 12 lumen extends to the spraying direction gradually, the spraying room 12 hatch gradual expanding can increase the spraying speed, and increase the energy usage rate, which is form the cylinder spraying part. The hatch on the air inlet pipe 18 along the cylinder section tangent, between the burning room 11 and spraying room 12 there is shrunken spraying hatch.

In the burning room 11 equips a lighter 10, which can adopt spark plug, and also can use one or two electrode to take place of the lighter. When using one electrode, the cylinder can be used as another electrode to realize lighting. When using two electrodes, they can be equipped in the cylinder in a certain distance, which is available for the small size nuclear reactor. On the cylinder two sides equip foundation support 9. Inside the cylinder should be fluent to form streamlined-shaped, especially for the spraying hatch to make air flow move fluently and reduce abrasion. For the mixed-air forming backset in the cylinder, a cylinder cone can be equipped on the cylinder bottom. On the cylinder inside wall can have screw thread whose direction is just opposite to backset cyclone rotating direction in cylinder. The screw's depth and length should be assured according to the cylinder's dimension; 55.62° is the best screw feeding angle. The reverse screw can accelerate the rev of the backset cyclone periphery and also can increase the relative rev in the backset cyclone center. At the same time between the cylinder side wall and backset cyclone forms a layer of wave, which can be better to insulate the energy of the backset cyclone from the cylinder side wall, in order to protect the cylinder and can reduce the abrasion to the cylinder side wall at the same time. If canceling the screw, it will not affect the cylinder working, only can increased the side wall's temperature so as to has increased the damage to the side wall and increase the cylinder side wall's energy loss, decrease the backset cyclone rev from the center to periphery relatively, decrease the backset cyclone rev relatively, so as to affect the cylinder's spraying speed, nuclear reactor's high-speed rev and even the whole nuclear reactor's function. For better heat dissipation, outside the cylinder can equip the screw or cooling fin. For avoiding too quick flow speed which is caused by the nuclear reactor high speed rotating make the attrition to the air-mixed room inside wall 4 and air intake pipe 18 inside wall too high temperature, horizontal screw can be equipped on their inside wall and form a inclining angle with the air current direction. The screw can produce a layer of wave, which can reduce the attrition heat greatly.

The cone 8 on the burning room can norm the rotation of the backset center, which is good for the backset forming. The whorl direction On the face of the cone 8 which is on the top of the burning room 11 can be the same with the backset cyclone rotation proceeding direction. It is not indispensable for the cone 8, without which the backset will be formed like each other, then for making the structure easy, the cone can not be equipped. We can adopt variable kinds of materials for the cylinder, in the usual case, the common engine cylinder material is just ok. The cylinder body can be shaped at one time adopted the foundry craftwork; and also can use the super ceramic cylinder which is heat resistance, which can enlarge the cylinder's usage life-span greatly, the cylinder can be made by ceramic material one time burnt. For the high demanded, the cylinder outer can be covered with metal or carbon fiber to strengthen the cylinder side wall's strength, which can also be covered with a barrel-shaped cover adopting the high-strength materials to stabilize the cylinder, on whose upper and lower side equip the foundation support individually 9, and mounting the lower foundation supporting with the flywheel 15 together tightly. The cylinder can be equipped with foundation supporting 9 directly when made. The ceramic cylinder and other kinds of cylinders not easy for installing the lighter 10 can use the barrel-shaped cover covered on the cylinder as the lighter's 10 foundation supporting. For increasing the attachment strength between the cylinder and flywheel, cylinder and flywheel 15 can be made together, and also can make air-mixed room 4, cylinder and flywheel 15 into one body. And also can use ceramic materials make it into style one time, whose usage life-span will be longer.

For using the energy well, the cylinder outlet should be aligned with the flywheel 15 edge. For preventing the high temperature extrusive air will damage the flywheel 15 edge, the sprayed part by the high temperature on the flywheel 15 edge can be gotten rid of, and then form a gap.

The cylinder of this invention has many forms; usually we often use first cylinder 13, second cylinder 14 and third cylinder 19, etc. The central axis line of first cylinder 13's cavity is bc, if the outlet end of first cylinder 13 and the flywheel 15 are aligned, the rad of the first cylinder 13's cavity's central axis line will be the same to the rad of the flywheel 15's edge, whether the 2 rad sides of first cylinder are equal or unequal are decided by the specific circumstances, a shorter inner rad side will improve the use rate of energy and torque, Φ3 is the included angle between the cables that made at the cylinder's exhaling end by the 2 rads and the tangent line of flywheel 15, we can choose 55.62° as the Φ3. we have many choices to choose about the radians of the first cylinder 13's central axis line, when we are doing the installation we should adjust the spraying angle of the first cylinder 13, in order to make the air-jet direction and the radius of the flywheel 15 on a certain angle so as to make better use of the reaction force of the jet thrust which is caused by the high pressure gas in the cylinder to resolve the centrifugal force, in that case, the nuclear reactors can make the high-speed rotation become true. When installation, we should make the top central axis of the first cylinder 13 as the pivot to reverse the first cylinder 13, that is to say, we should adjust the spraying direction of the cylinder and the plane angle between the flywheel 15 and the flywheel axis 3 so as to make the change of the nuclear reactors' functions become true.

The inner central axis of the second cylinder 14 is a non-circular curved line, using the combustion chamber 11's jetting exit site as the included angle's intersection point to make up the bending line structure of the inner central axis, in order to make the inner central axis of the cylinder bending from the combustion chamber 11's jetting exit site. When we are doing the installation, we should make the inner central axis of the jetting room 12 as the standard, let the inner central axis of the combustion 11 become parallel with the radius of the flywheel 15, that is to say, it is ok to make an tilt angle between the inner central axis of the combustion room 12 and the radius of the flywheel 15. When installation, we should make the top central axis of the second cylinder 14 as the pivot to reverse the second cylinder 14, that is to say, we should adjust the spraying direction of the cylinder and the plane angle between the flywheel 15 and the flywheel axis 3 so as to make the change of the nuclear reactors' functions become true. This program of the cylinder curved line structure also help the formation of the vortex cylinder, at the same time, we use the reaction force of the jet thrust to resolve the centrifugal force of the flywheel 15, what's more, it will make the installation simple, and reduces the cost, but it is somewhat less worse than first cylinder 13 in the effect.

The central axis of the third cylinder 19 lumen is beeline, which makes the cylinder as a straight cone. This kind of cylinder workcraft is also relatively easier, but the usage affection is not that ideal, which is not good beneficial for forming backset and simplifying the installment, especially it will make the installment structure complex relatively when exporting the torque force and thrust force together.

When used, the central axis of the cylinder lumen usually adapts curve line.

Cylinder has many kinds of geometry structure, it may be barrel-shaped, jet mouth slightly contracted structure, jet mouth opened structure, it can also be a barrel-shaped that jet mouth opened structure; it can also be a kind that installs a vortex generated room on the top of the combustion chamber 11, in that kind, there is a reduced combustion chamber air inlet port between the vortex generated room and the combustion room 11, this structure can reduce the temering and the effect is not so obvious. All those above mentioned kinds are not conductive to maintaining the inner cylinder combustion, and the formation of the cylinder swirl.

It is better that if the jet orifice area of the combustor 11 is a little less than the inlet area, it will be useful for raising the pressure of the combustor 11, but if it is too small it will lead to flashback, at the same time it will heighten the pressure drop, reduce the rate of energy efficiency, resulting in energy loss, so we can choose different area size of the jet orifice and the inlet area on our demanding. If the size of the jet orifice is larger than the inlet area, it will be difficult to light up and maintain the burning, what's worse, we can not light up. If the size of the jet orifice is equal to the inlet area, basically we can light up and keep on burning but it will influence the pressure in the cylinder, it will a little hard for us to light up, so it is better that we choose the kind that the jet orifice is smaller than the inlet area.

The nuclear reactor needs a high speed nuclear reactor rpm to actualize the nuclear reactor's lighting up and burning. We can refer to the area size of the ramjet's jet orifice and inlet port to adjust the size of the jet orifice, if the inner air flow of the cylinder is a kind vortex flow that can help doing rotating forward motion, it can also help for lengthening the time that the air flow maintaining in the cylinder, and better keeping on burning. The best proportional range of area size of the ramjet's jet orifice and inlet port is 1: 0.618-1: 10 When the size of the jet orifice is larger than the inlet area in combustion room 11, we can install the igniter 10's ignition nearby the cylinder combustion room 11's jet orifice, it will be easier to lighten up, at the same time we can avoid the tempering, and we can use conventional spark plugs to ignition device 10.

It is better to make the cylinder spraying end and the flywheel aligning, the length of the cylinder lumen section diameter is about 0.382 times of the cylinder lumen central axis length, by which can make the cylinder size coordinating with the flywheel's 15 size, and also the cylinder's length coordinating with the width. Under the phenomenon of cylinder length unchanging, if the cylinder spraying end and the flywheel 15 aligning, when lengthening or shortening the flywheel's 15 diameter, the nuclear reactor can also rotates, while its coordination and capability will be decreased. Variable kinds of dimension rate can be chosen according to the different demands, including: the rate of the length of cylinder lumen central axis and the flywheel diameter, the rate of the diameter of the max cylinder lumen section diameter and the length of cylinder lumen central axis, the rate of the two length of spraying 12 lumen central axis and the cylinder lumen central axis; the lumen central axis is curved, the two sides of the curved angle can choose different length rates, among which the golden section rate will be the best.

The incline angle which is formed by cylinder spraying direction and flywheel 15 diameters will be able to make the nuclear reactor rotating. The best angle Φ1 slope between the cylinder spraying direction and flywheel 13 semidiameter should be 55.62°-68.76°. this kind of installment schedule will help the nuclear reactor conquer part of centrifugal force, which is to conquer most of the giant centrifugal force produced by the nuclear reactor high-speed rotating, which is able to make the nuclear reactor rotating with the high speed, so that the nuclear reactor needn't be worried to be separated by the centrifugal force and also decreases the demand for the flywheel's 15 material. Only if adjusting the angle between the cylinder spraying direction and the flywheel's semidiameter, the nuclear reactor's adjustment ability to rev will be changed.

The spraying angle formed between the cylinder spraying direction and flywheel semidiameter or the cylinder spraying direction and the flywheel plane which is perpendicular to the flywheel axis 3, can change the nuclear reactor functions. When the cylinder spraying direction is paralleled with flywheel plane which is perpendicular to the flywheel axis 3, the nuclear reactor can export the torsion force; when the inclining angle is formed between the cylinder spraying direction and the flywheel plane, the nuclear reactor can export both the torsion force and the thrust force. Adjusting the angle between cylinder spraying direction and flywheel plane which is perpendicular to the flywheel axis plane, can realize the nuclear reactor's function changing. The cylinder spraying direction, which is affected by the lumen central axis of cylinder spraying section, is almost parallel to the lumen central axis in the cylinder spraying section, when installed, the cylinder spraying direction can be adjusted subject to the lumen central axis in the spraying section.

For assuring the backset's formation, the air inlet can be equipped on the direction of cylinder lumen section tangent, the hatch of the air pipe is on the top of burning room 11 along the tangent direction of the cylinder section, so that the air can be push into the cylinder along the tangent direction. Variable kinds of shapes can be chosen for the cylinder air inlet section, round, square, triangle, polygon, arcs, irregular shapes are all ok, but the rectangle is the best, the long line of the rectangle is parallel with the cylinder central axis, which is good for forming the backset. Moreover, the air-intake pipe 18 lumen is expending to the air-mixed room 4 direction gradually, which will increase the air-intake pressure further.

It is better for the air intake hatch and the nuclear reactor rotating with the same direction, which will be useful for the air flowing into the cylinder. That is because when the air curving speed lower than the air-mixed room 4 wall feeding speed, the rev speed quicker, this point will be embodied out better. We can fully use this point to make air enter alongside the direction of cylinder lumen section tangent better, and fully use the inertia impulsive force, which will be good for increasing the backset rotation speed in cylinder. The higher of the flywheel 15 rotation speed, the better for the backset formed in the cylinder, and also good for increasing the backset rotation speed in cylinder.

When installation, make the hatch of the air intake pipe 15 pointed to the nuclear reactor rotating direction, meanwhile, you should also make the air intake pipe 18 hatch direction inclined to air-mixed room 4, the hatch can be on the side of the air-mixed room. The inclining angle should be better being smaller which can make the air intake pipe 18 fluently as a streamline to make the air current flowing into the cylinder fluently. The expanding hatch of the air intake pipe 16 makes the air current entering the air pipe 18 easier, increase the air intake pressure greater and avoid the backfire better synchronously.

The lighter of the cylinder 10 is connected with lighting system, which includes the power supply, switch, high pressure transformer, circuit etc. the power supply can be equipped with a generator which is driven by the nuclear reactor and supplies electricity to storage battery, and also can use the exterior power supply directly, so as to leave out the generator, storage battery and other equipments. Every parts of the lighting system are integrated in the lighting equipment, which can be equipment on the flywheel axis 3 and connected with the lighter 10. The lighting circuit is connected with the exterior lighting circuit through the electricity brush on flywheel axis 3, there should be insulation material layer between the electricity brush and flywheel axis 3, the high pressure wire used for connecting the electricity brush connects the lighters 10 of every cylinder along the flywheel 3 to the flywheel surface. Another electricity brush of high pressure wire can be equipped on the clutch which is controlled by the electric magnet, both the two brushes can be formed into an electric on-off brush, the power up and power off of the electric magnet can make the two brushed on and off, the on-off brush can avoid the damage to electric-brush because of the nuclear reactor high speed rotating.

The lighting equipment also needn't to use the on-off electric brush. Cancel the clutch and make a certain clearance between the two electric brushes to form the off brush. Use the high pressure electricity to breakthrough the brushes clearance directly to switch on the circuit, which can also avoid the inter-attrition between the two brushes, so as to simplify the electric-brush installment structure. Also can equip an axostyle on the flywheel center, fix the electric-brush on the axostyle, the scheme result is not that reasonable so it is rarely used. For simplifying the installment avoiding series of problems such as high pressure circuit damage, the high pressure circuit and the electric brush can be canceled, only need to install one or several electrodes above the flywheel 15 near the lighter 10, installing a circle of high pressure electrode is better, electrode connecting with the lighting circuit will be much better for realizing lighting. When installing the lighter 10, make the lighter's wiring terminal near the electrode, and leave out a certain clearance, then the high pressure can breakthrough the clearance and realize the circuit connection. When installing one or several electrodes, along with the flywheel rotation, the lighter on the cylinder will move to the electrode below and connected with the circuit for realizing the lighting. This scheme is the best one for realizing the nuclear reactor lighting.

The lighting system also can not adopt the above lighting equipment, while be made into the micro-lighting equipment which can be installed beside the lighter on each cylinder. This method is with high demand and high cost, not as good as the above scheme.

Because there is no interface of the nuclear reactor which is adopting magnetic bearing 25 connected with the shell body 23, for realizing the connection with the circuit, an earthing electrode should be installed. A separating electric brush can be equipped on the flywheel axis 3 in order to make the high pressure electricity cathode and the flywheel 3 connected, which can make the lighting circuit form loop.

Starting system includes the electricity supply, switch, circuit, starter, transmission equipment etc. the nuclear reactor should be started through the starting system equipment when using to achieve the initial rotating speed. The starting equipment can be installed on the flywheel axis 3 directly, which can also drive the flywheel axis rotating by the exterior electricity power, so as to provide the initial rotation speed for the nuclear reactor. It adopts the common starter engine, which should be separated from the nuclear reactor after its starting by the clutch cover.

For simplifying the structure, the lighting system equipment and the starting system equipment can be produced together, which is that install the starting equipment 1 on the flywheel axis 3, and also can install the starting equipment on the magnetic bearing exterior magnet. The lighter starting equipment 1 can generate electricity at the same time, when used, start the lighter equipment 1 and make the flywheel 15 rotating by exterior electricity. After the fuel and air entering from the air inlet 2 into the air-mixed room 4, the mixed fuel and air enter into the cylinder through the air inlet and air outlet, because of the centrifugal force and the effect of inertia, the mixed air in cylinder will form a high speed and high pressure backset, the lighting equipment will control the lighter to light on the mixed air, then the air swollen and ejected, which will push the flywheel 15 rotating. Then we can close the starting function of the lighter equipment 1 to realize high speed self-rotation, exporting the energy and shut down the lighting circuit of the lighting equipment 1 at the same time, in order to avoid the lighter 10 damage.

For increasing the whole equipment's strength, improving the anti-centrifugal force ability, mounting plate 7 can be installed on, opening holes on it will not affect the air entering the air-mixed room, whose edge reaching to the cylinder part and cover on it. Above the cylinder is equipped with pedestal 9, connecting the mounting plate and the pedestal of every cylinder together will increase the strength greatly, also will not affect the heat dissipation. When producing, enlarge the air-mixed room, mount the air inlet edge and the mounting plate together, which will be good for increasing the strength further. Add a supporting plate on the mounting plate edge, which will increase the strength further. Making the supporting plate and mounting plate into one body, connecting the supporting plate and flywheel together, will form a whole body, which will make the whole equipment more stable.

One first operating structure of this invention is: installing a cylinder surrounding the flywheel 15, opening an air inlet 6 on the upper wall of the cylinder bottom, opening an air outlet 5 on the lower wall of the air-mixed room 4 periphery, connecting the upper air inlet 6 and the lower air outlet 5 together. The whole structure in this example is stable, which can make the air-mixed room 4 and the flywheel mounting together, with high strength ability, so as to realize the nuclear reactor rotating with high speed. In order to increasing the total intensity, you can install a convex plate on the flywheel 15 surface, and install the air-mixed room 4 on the convex plate 17 to make the air-mixed room 4 edge covering the cylinder air inlet, then make the cylinder air intake pipe hatch inclining to the flywheel 15 top. Mounting the air-mixed room 4 and cylinder together and mounting the cylinder and flywheel 15 together to enlarge the air-mixed room edge, by this can form a special mounting plate, being covered on the cylinder. Make the mounting plate connected with the supporting plate, mounting the supporting plate and flywheel 15 together, which can make the cylinder pressed between the flywheel and air-mixed room tightly. Both the mounting plate and supporting plate should be thickened, both which can be produced together, can also be produced into one body with the air-mixed room. By this structure, the nuclear reactor strength will be increased greatly in order to eliminate the centrifugal force.

The second operating structure is: equip an air-mixed room 4 in the flywheel 15 cylinder, open an air inlet 81 on the cylinder bottom lower wall, open an air outlet 51 on the lower wall of the air-mixed room 4 periphery, and connect the low air inlet 61 and the upper air outlet 51 together. This structure example is easily installed.

The third operating structure example is: on the air-mixed room 4 side equipped an air inlet 52, open an side air inlet 62 on the cylinder bottom side. As per the flywheel 15 rotating need, an air inlet can be opened on the normal side and reverse side of the cylinder bottom. This operating example is relatively complex and not ideal result. The air intake pipe 18 is parallel with the flywheel 15 surface and corner-turning opened to the air-mixed room 4. In order to increase the air intake pressure, the intake pipe 18 lumen can be expended to the air-mixed room 4 direction gradually. The shortage of this operating structure is that the intake pipe 18 takes up part of space resulting in reducing the installed cylinder quantity, whose result is not that ideal.

For increasing the energy supplied from the reactor, an air-mixed room 4 can be equipped on the flywheel 15 up and bottom two sides, on each up and bottom two sides should be installed a cylinder individually. For the format of two-faced flywheel, we can also adopt the structure of two-faced cylinder using a common air-mixed room 4, which is: on the up and bottom two sides should be installed an upper cylinder 40 and lower cylinder 16 individually, and open a lower air inlet 60 on the lower wall of the upper cylinder 40 bottom, open an upper air inlet 6 on the upper wall of the lower cylinder 16 bottom, equip an air-mixed room 4 on the flywheel 15 center area. On the upper wall and lower wall of the air-mixed room 4 periphery can be opened an upper air outlet 51 and lower air inlet 5 individually, the lower air outlet 61 should be connected with the upper air outlet 51, the upper air inlet 6 should be connected with the lower air outlet 5. On the flywheel axis 3 can be installed several flywheels 15. The other structure in similar with the single flywheel's structure. These schemes are not commonly used, that is because the nuclear reactor speed is extremely high. Along with the rev increasing, its power will be increased synchronously, its power can be extremely big, power range can be wide, even if really small nuclear reactor can export extremely great power.

Because of the nuclear reactor with really high rev, it can be not equipped on most of the energy-required equipments directly, should be installed on the generator, using the generator to export high frequency electric current and turning the electricity into the energy. The generator can use the magnetic force bearing axis 25, and also can use the common magnetic force bearing axis 25 with the nuclear reactor. Because of the rev too high, the electricity brush connected with the electric circuit in the generator can not bear the high rev, the generator can adopt the structure of the exterior magnetic field rotating with the flywheel axis 3 and the generator circuit installing in the magnetic field.

Nuclear reactor and generator can be made into one body, whose structure is: the flywheel axis 3 diameter can be longer or equal with the one of flywheel 15, the flywheel axis 3 can be produced into barrel-shaped permanent magnet. Make the flywheel 3 as the outer magnetic field of the generator and starter, equip bracket 31 on the shell body 23, and extend the bracket into the flywheel 3 lumen, equip the first permanent magnet 30 and the first circle 28 on the bracket, the flywheel rotation can drive flywheel axis 3 (barrel-shaped permanent magnet) rotating to make the first circle generate electricity, and export the electricity power. Supplying electricity to generating circles and transform the current direction at the same time can make flywheel axis 3 rotating, which can start the nuclear reactor. Both flywheel 3 and the first permanent magnet 30 can compose magnetic bearing together, and also assemble the generator and starter together. You should adjust the geometric structure of the barrel-shaped permanent and the first permanent magnet well and also their magnetic field.

Within the implementation of this case, in order to improve the overall strength, you can made flywheel axle 3 and the flywheel 15 into a whole. The magnetic bearings 25 with the flywheel 15, flywheel axle 3, generators, and starters assembled together. This program is the most commonly used programs in the invention. Within this case, in order to enhance the magnetic field strength, it can be installed in the flywheel axle 3 with the second coil 29, in which set electromagnet, and the second coil 29 generate electricity to supply to the electromagnet. The nuclear reactor of this invention can achieve not only the output thrust, but also the output torque, and this invention can constitute the nuclear reactor with the output torque and the output thrust: flywheel 15 is installed thrust cylinder 36. Between the jet direction of the thrust cylinder 36 and the plane perpendicular to the flywheel axle 3, in which the flywheel 15 is located, the angle is Φ2, and it's a non-zero angle. If the angle is too large, it will prevent the nuclear reactor's speed. More little angle demands higher flywheel's speed, with which it can output a greater thrust. The best value range of Φ2 is: 10°-34.38°. The smaller the angle, the easier it is to improve the speed of the nuclear reactor, the jet propeller formed has a higher speed, then make a greater thrust to promote a higher speed. Thrust cylinder 36 can use the first cylinder 13 or the second cylinder 14, and the central axis at the top of the first cylinder 13 or the second cylinder 14 as the axis, just be reversed a certain angle, to make the angle between the jet direction of the first cylinder 13 or the second cylinder 14 and the plane perpendicular to the flywheel axle 3, in which the flywheel 15 is located, is just greater than zero degree. Thrust cylinder 36 may also use the third cylinder 19, as long as readjust the jet direction and the jet angle. But it's more cumbersome and the using results are not satisfactory. The flywheel axle 3 of the nuclear reactor, which can output both thrust and the torque, can be directly installed on the aircraft, and it can give rise to the aircraft different thrust or pull indifferent surfaces of the flywheel. When both flywheel axle 3 and propeller jet are in the same side of the flywheel 15, that is when the angle between the jet direction of the cylinder and flywheel axle 3 is less than 90 degrees, it will result in tension on the aircraft. Flywheel axle 3 and propeller jet are not in the same direction of the cylinder and flywheel axle 15 is greater then 90 degrees, resulting in the aircraft's thrust.

The nuclear reactors which can output thrust and torque, can be used for a variety of aerospace, aviation aircraft, including rockets, aircraft, and spacecraft. The air it exhaled is the cyclone vortex flow with the speed decreasing form the center to the periphery. The front of vortex flow formed a cone, the cone-tip high-speed rotation. The propeller vortex flow likes a spin-bullet with a faster speed and thrust. At the same time, greatly reduce the noise. As long as the flywheel 15 and the bearings can bear, the higher the speed of nuclear reactors is, the higher power will be.

The concrete structure of the exporting thrust and torsion force nuclear reactor is: install the thrust cylinder 36 and air-mixed room 4 on the flywheel 15. Open an air inlet on the thrust cylinder 36, and open air outlet on the air-mixed room 4, the inlet and outlet are connected. The thrust cylinder 36 spraying direction should be inclined to flywheel 15 slanting inferior. The angle between the thrust cylinder 36 plane and flywheel 15 plane which is perpendicular to the flywheel axis 3 plane is not zero, the best angle range is: 10°-34.38°. The angle between thrust cylinder 36 and flywheel semidiameter is not zero, the best angle range is between 55.62°-680.76°.

This kind of nuclear reactor can use the normal fuel as the engine for routine power, which can also adopt any kind of element as the nuclear fuel, that is, it can burn the air directly, makes the elements in air taking place of nuclear reaction; and also can make the hydrogen element taking place of the nuclear reaction, and even use the quanta in vacuum as the nuclear fuel, which is really important in spaceflight.

When the rotate speed of nuclear reactor reaches that it can use air as nuclear fuel, the inlet control equipment 26 need installing in the shell body 23, and inlet control equipment 26 corresponds with air inlet 2. Inlet control equipment 26 can not only be installed into shell body 23, but also into flywheel 15. However, if it is installed into flywheel 15, it will easily affect the whole intensity of flywheel 15. So it is not generally used. Besides, inlet control equipment 26 installs expansion bend, which sets up sealplate 27. Expansion bend is controlled by control system in order to keep sealplate 27 stable when it moves up and down. It must be installed between expansion bend and sealplate 27 that magnetic force bearing axle 25 or other bearings equipments supporting extremely fast rotate speed, which can make sealplate 27 rotate at a high speed. A slab staggering need to be made in the sealplate 27 and magnetic force bearing axle 25 is attached onto it so that the clearance of magnetic bearing has no influence on the airproof of sealplate 27. The position between inner magnate and outer magnate of magnetic bearing 25 need designing inclined surface or cambered surface or flute profile, so that it can support the parallel force of the slewing axis of magnetic bearing 25, making sure that seal plate 27 can move up and down. When sealplate 27 approaches air inlet 2, the air input of nuclear reactor lessens and makes the intensity of nuclear reactor reduce, the control sealplate 27 is able to control the rotate speed and power of nuclear reactor. Then, when sealplate 27 seals air inlet 2 completely, it can make nuclear reactor cease fire with the high-speed rotating of flywheel 15. The sealplate 27 of nuclear reactor which can output torque force and thrust can be attached onto flywheel shaft, which rotates simultaneously with flywheel shaft 3, glides up and down along the flywheel shaft 3 and keeps no space with flywheel shaft 3. The seal oil can both make flywheel shaft and sealplate 27 glide up and down and make the space between them seal. Magnetic force bearing axle 25 is installed onto sealplate 27 and it also connects the expansion bend, which increases retractive force and makes sealplate 27 and air inlet 2 separated again once sealed, because the air inlet of high-speed rotating nuclear reactor can produce a strong suction. Once sealplate 27 and suction port contact, they are not easily separated leading to the cease fire of nuclear reactor. In order to avoid that, sealplate 27 and suction port 2 must be separated again, so we should increase the retractive force of expansion bend and reinforce suction pore 2 so as not to make suction 2 move with sealplate 27. For realizing the separation better, the sealplate can be designed into super-magnet, around the air inlet 2 also should be installed a circle of super magnet, then they wont be easy to be connected together. For preventing the usage of the air controlling equipment 26 affected by the fuel pipe, the fuel pipe 20 should be designed into the telescopic or swinging structure, after the nuclear reactor realizing the nuclear reaction, the fuel pipe will get away of the air inlet 2, which will not affect the sealplate 27 working.

When using the nuclear reactor of this invention, it should be started the lighter equipment 1 first to make the reactor flywheel 15 rotating, as the rotation of the flywheel arrives at a certain speed, the air will be inhaled into the air-mixed room 4 automatically, and the mixed air in the room 4 will form an rotation speed increasing backset cyclone from the center to the surrounding, which will increase the air pressure on the air-mixed room 4 edge, and make the air and fuel mixed symmetrically. Under the influence of centrifugal force, the fuel mixed gas enters into the burning room 11 and then form a rev decreasing backset cyclone from the center to the surrounding. The lighter starting equipment will control the lighter 10 lighting to make the backset cyclone burning, which will lengthen the fuel's staying time in the burning room 11, in order to make the fuel and air mixed well and also ensure the fuel burnt completely. Once the backset cyclone is formed, there will be a cyclone in the burning room 11. the mixed-air will flow from the backset into the backset center fully, burning the more fuel added in will release more energy to quicken the rev of the backset cyclone center, and increase the decreasing rev from the center to periphery, then it can increase the relative rev of the backset cyclone to ensure more energy will centralize in the backset, so that the burning room 11 will produce a high-temperature and high pressure environment in the central area.

The high pressure air is expelled from the whiff room 12 and changed into thrust force to push the flywheel 15 rotating. The flywheel 15 edge also for a rev decreasing backset cyclone from the center to periphery, then it can also greatly decrease the nuclear reactor's noise. When the whole nuclear reactor working, there is no roaring sound, no vibration, no dithering etc. once lighting, the nuclear reactor will not need the outside force pushing anymore, it will realize self-rotating with high speed and output power, at the same time the lighting supply of the lighting starter will be shut down.

Working principle: a high pressure barrel-shaped pipe from the cylinder backset center, when the periphery rev decreasing, the backset cyclone center will be bigger relatively, and also the pressure on backset center area bigger. At the same time, because of the flywheel 15 rotating with high speed, the backset cyclone also rotates along the façade axis with high speed. The flywheel 15 rotates a circle; the backset cyclone also rotates a circle alongside the façade axis, just like the moon rotating around the earth, whose revolution and rotation are synchronous. The cylinder rotation driven by the flywheel will make the backset cyclone in cylinder revolution around the flywheel axis 3, whose revolution rotating a circle and rotation along the façade axis are synchronously, and also will make the backset cyclone owning a plane rotating torsion force of the backset cyclone itself and façade rotating torsion force produced by revolution at the same time, then the reciprocity of the two forces will produce a separation force on the atom. The atom in backset cyclone will also receive the rotating torsion force with rotation and revolution together just like the moon.

When the flywheel 15 speed arrives at an extreme speed, the façade rotating speed in nuclear reactor will be synchronous with the flywheel rotation speed, which will make the façade rotation with an extreme field rotation speed. After the atom entering into the nuclear reactor air-mixed room 4 through the air inlet 2, the atom field rotation will be suddenly sped up under the affection of nuclear reactor field. The speedup speed is extremely high, the atom field balance state will be broken when reaching to some degree, and changed the atom structure into the plasma.

A high pressure and high temperature area is produced in the cylinder backset cyclone center, when with high rotating speed, the temperature and pressure will be very high. When entering into the cylinder backset cyclone center area, the plasma atom will be cut down. The backset cyclone rev is decreasing from center to periphery, different semidiameter circles are with different linear speed, which will produce friction between the neighboring circles. At the same time, between this backset cyclone rotating axis and the backset cyclone rotating axis in the air-mixed room 4 there is a cross angle, which will make the plasma atom cut by the backset cyclone and the plasma atom separated, the nuclear reaction is taken place. The intercut between plane rotating torsion force and façade torsion force will affect atom taking place nuclear reaction. If the rev is high enough, hydrogen atom will also take place nuclear fission reaction. The other elements will also take place variable kinds of complex nuclear reaction.

It requires high speed reaching a certain speed to realize the nuclear reactions. First it can realize the nuclear reactions of atom with high atomic weight and gaseous atomic is easier to implement the nuclear reactions. Once the nuclear reactions are fired, the speed of nuclear reactor becomes higher and the temperature and pressure of vortex cyclone center in cylinder becomes higher. But there is little change in the temperature and pressure to cylinder wall. Along with the speed further improved, nuclear reactors will intensify and they will take place in all kinds of elements. To accelerate, fission reactions will occur in hydrogen atomic. At that time, nuclear reactors will radiate energy flow composed of quantum, neutrino and quark and so on.

It depends on the speed of the nuclear reactor, without the relation with flywheel 15. It has a litter relation with high temperature and pressure in cylinder and it do not require high temperature and pressure but high speed of flywheel 15. The vortex cyclone with speed decreasing from center to surrounding makes the temperature and pressure to cylinder wall not too high. To realize the fission reaction of hydrogen atom, there are high requirements to the speed of nuclear reactions and the material intensity of flywheel 15 and cylinder. For astro navigation, little fuel will complete it. At the same time, a lot of hydrogen atom existing in universe can be used to add fuel. Any kind of element can be used as unclear fuel.

The lower speed of nuclear reaction can deal with rubbish and all nuclear waste. The rubbish can be used as nuclear fuel and at the same time, the rubbish can be changed into valuable element. If the speed of nuclear reactor is adjusted, it can make some elements steadily, can make rubbish into valuable elements, rare element, can make gold, more new elements and can bring into the revolution of material industry and thoroughly solve resource problem. The whole process is no pollution. The overall structure size is bigger. It can be used to make valuable element such as gold, rare element. It can product lots of new material. Also it can be taken as a kind of thermal equipment, such as new furnace, reactors furnace, melting furnaces, converter, calcinatory with better performance than all of the equipment using and better product quality. It can produce super high temperature and pressure in cylinder. So All kinds of raw atoms becomes plasma, and can occur various complex nuclear reaction, high temperature physics and chemistry reaction, can produce various isotopes and new elements, and then they can will react to make all kinds of new materials.

We can use it to produce a lot of man-made diamond, whose quality is even better than the natural diamonds. We can also use it to produce cement, ceramic frit and other materials, etc. the materials which is needed to be burnt should be made into powder or slop, which can be exported by air flow or slop pump, which can also be exported to the nuclear reactor directly by a filler equipped on the nuclear reactor air inlet hole, a rotating screw pole driven by motor can be added in the filler to leak the material down uniformly. Once the backset cyclone in the cylinder burning room 11 formed, a backset can be formed on the burning room 11 air inlet place, the fuel mixed-air and the material which is needed to be burnt can flow from the backset into the backset cyclone center fully, then a high temperature and high pressure environment can be produced in the cylinder backset cyclone central area, every kind of material can realize variable kinds of high-temperature reaction and can take place the crystal and other series of complex physics and chemistry reaction. Enlarging the nuclear reactor and fuel supply can improve the high temperature and high pressure environment in the burning room 11, and even produce a super high temperature and super high pressure environment, in result to create conditions for producing variable kinds of materials.

Make the shell body of the nuclear reactor into the storage bin, and equip the nuclear reactor on the bin top, make the material bottom barrel shaped or export equipment to export the products.

For example, when producing cement, ceramic frit, alumina etc, make the materials into powder or slop, which can be exported into nuclear reactor directly, the methods to produce other materials is almost the same, only need to adjust the nuclear reactor's dimension and its rev according to the need.

For example, to produce man-made diamond, the pure carbon powder can be supplied. When nuclear reactor moving normally, the carbon powder can crystallize the man-made diamond under the high temperature and high pressure environment, enlarging the nuclear reactor dimension also can produce bigger man-made diamond, whose quality is even better than the natural ones. The oxygen in the storage bin should be controlled at the same time, can make the insulation cover 21 near the nuclear reactor air inlet hole 2, which can make the clearance between 21 and 2 is really small, so that less air will enter into the storage bin. Cooling the cylinder can adopt the water spraying method, only need to equip a spray nozzle on the flywheel 15 top. The material flowing from the storage bin can screen out diamond through panning and filtering, the left tankage after dehydration can reenter into the nuclear reactor to be reburnt, the dehydrated water can be recycled. For increasing the diamond's purity, it is better to use pure water to cool the cylinder.

it can produce BN, CNX crystal, Pt-N and other materials which are difficult to product by the recent materials, can produce chemical compound complexes by several isotopes, can produced many unnamed new elements and new materials, and can turn the rubbish into gold or other expensive and rare elements. Just adjusting the nuclear reactor's rev can produce different kind of elements or materials. Different rev can produce out different material with different components rate, which can produce the needed subjects after abstracting. It can bring to material industry revolution and solve the resource problem thoroughly.

The nuclear reaction is carried out in the cylinder. Used as the energy, we can adopt the air as the fuel directly, no need any nuclear radiation and nuclear pollution, which is poured out is particle flow, no need any radioactive elements and no harmful gas. It is nuclear burning while not explosion in the cylinder so it is really safe. The nuclear reaction is taken place on the backset cyclone central axis, the backset cyclone can eliminate the energy to the cylinder wall, also the energy sprayed out and variable kinds of radiations, particle flow can be eliminated by the backset cyclone surrounding the flywheel 15, adding the shell body 23, by all can be better to insulate the nuclear radiation. By controlling the fuel supplying quantity can be easy to adjust the nuclear reactor's rev and control the nuclear reaction strength, so we needn't to worry about the nuclear safety problem, besides, the energy released from the nuclear reaction is centralized in the backset cyclone center of the cylinder and can adjust the nuclear reactor strength at any moment. We can make the atom taking place slow nuclear fission reaction, even only let atom releasing energy while not atom change, for example, only let oxygen element release a small part of energy, being poured out from the nuclear reactor is still the oxygen element, only its atom quality has been changed, so there is no any nuclear pollution and nuclear safety problem at all.

The automobile can also use the nuclear energy, using air as the nuclear fuel directly, which can use a generator driven by a small size nuclear reactor to make the automobile moved by an engine. We can also use hydrogen gas as the lighting fuel. Small car can also use the hydrogen as the regular energy directly; this kind of hydrogen gas is relatively cheep, which is only a tenth part of the recent gasoline price. The small car can also be made into the storage battery to drive the electromotion car.

Train can also use the nuclear energy, which is no need to carry on the railway electrization, so as to save the construction money of the railway circuit. There is also no need for the power station to set the grid, and eliminate obstacles for the lower flying, which can be used in power utilization places: plants, communities, and even for the families, installing a nuclear energy generator to supply the electricity directly. The ships can also use the nuclear reactor, which is also for plane, rocket and spacecraft. The nuclear reactor can be made into small size, as the technology develops, nuclear reactor with flywheel 15 whose semidiameter is smaller than 10 cm can be invented, by which can generate powerful electric current to drive ten thousand ton-class ships running with high speed. Because of no limit for its rev, the rev is higher, the power will be greater.

This kind of nuclear reactor can solve the energy problem thoroughly, and solve the environment pollution problem. The electricity charge can be down to the lowest and even free. Then we should not need the coal and petroleum any more, just uses the cheap power to electrolyse the water into hydrogen gas. Use the hydrogen gas for burning, then hydrogen and oxygen can be reacted into water, which would make water recycle used. Only use electricity power energy is just ok, then the energy problem would be solved thoroughly, there would be no greenhouse gases exhausted. Meantime, the environment problem would be solved completely, the air would be much clearer and the human beings healthier. There would be a material revolution as well, so that more new materials would be produced, the world is much more brilliant, the rare resources be man-made, gold be as cheap as the steal, and the resource problem could be resolved thoroughly. The energy and resource problem bothering the human beings would also be eliminated thoroughly, so as to change the human's life. Use the cheap energy to desalt the sea waters to supply the freshwater, which could change the desert into marsh, forest and oasis, and also can change the environment on the earth, by which the future would be much better.

The technology scheme in this invention is not limited in the operating examples' scope. Some technology contents which are not described in this invention essay are all common senses.

1. A nuclear reactor comprising:
a shell body (23), a lighting system, a starting system and a fuel system;
the shell body (23) has a magnetic force bearing, in which a flywheel axle (3) is installed and a flywheel (15) is installed on the flywheel axle (3);
a gas-mix room (4) is installed on the flywheel (15), the gas-mix room (4) has a gas holes (2) in its middle; cylinders are installed in outer circum of the flywheel (15),
there are gas outlets in outer circum of the gas-mix room, and air inlets on bottoms of cylinders, the outlets and inlets are interconnected, a lighter (10) is installed in cylinder, an angle between a cylinder's spraying direction and a flywheel semidiameter is Φ1.

2. The nuclear reactor of claim 1, wherein there is an induction trunk (18) in gas inlet, one top of the induction trunk (18) has same direction with the flywheel (15), other top of the induction trunk (18) and cross section tangent of cylinder lumen with the same direction, in the cylinder a firebox (11) and a spraying box (12) are installed, a cross section area of the latter's inlet section is smaller that the former's, the spraying box' (12) lumen is extended to flywheel (15) edge.

3. The nuclear reactor of claim 3, wherein a central axis of cylinder lumen is curve.

4. The nuclear reactor of claim 1, wherein there is upper air inlets (6) on cylinder bottom upside, lower air outlets (5) on downside of gas-mix room outside (4), the lower air outlets (5) and upper air inlets (6) are interconnected.

5. The nuclear reactor of claim 1, wherein lower air inlets (61) in cylinder bottom outside, upper air outlets (51) on gas-mix room (4), the lower air inlets (61) and the upper air outlets (51) are interconnected.

6. The nuclear reactor of claim 1, wherein there is side air outlet (52) on air-mix room (4) side, side air inlets (62) on cylinder bottom side, the side air outlet (52) and the side air inlets (62) are interconnected.

7. The flywheel engine of claim 1, wherein there is gas-mixed room (4) installed on upper and lower side of flywheel (15) individually, and also cylinders on both sides.

8. The nuclear reactor of claim 1, wherein the cylinder is pushing cylinder (36), whose spraying direction and the flywheel plane form the corner of Φ2.

9. The nuclear reactor of claim 7, wherein the cylinder is pushing cylinder (36), whose spraying direction and the flywheel plane form the corner of Φ2.

10. The nuclear reactor of claim 1, wherein shell body (23) is installed gas inlet controlling equipment (26), which is corresponding with the air inlets (2).

11. The flywheel engine of claim 2, wherein there is gas-mixed room (4) installed on upper and lower side of flywheel (15) individually, and also cylinders on both sides.

12. The flywheel engine of claim 3, wherein there is gas-mixed room (4) installed on upper and lower side of flywheel (15) individually, and also cylinders on both sides.

13. The flywheel engine of claim 4, wherein there is gas-mixed room (4) installed on upper and lower side of flywheel (15) individually, and also cylinders on both sides.

14. The nuclear reactor of claim 2, wherein the cylinder is pushing cylinder (36), whose spraying direction and the flywheel plane form the corner of Φ2.

15. The nuclear reactor of claim 3, wherein the cylinder is pushing cylinder (36), whose spraying direction and the flywheel plane form the corner of Φ2.

16. The nuclear reactor of claim 4, wherein the cylinder is pushing cylinder (36), whose spraying direction and the flywheel plane form the corner of Φ2.

17. The nuclear reactor of claim 5, wherein the cylinder is pushing cylinder (36), whose spraying direction and the flywheel plane form the corner of Φ2.

18. The nuclear reactor of claim 6, wherein the cylinder is pushing cylinder (36), whose spraying direction and the flywheel plane form the corner of Φ2.

19. The nuclear reactor of claim 11, wherein the cylinder is pushing cylinder (36), whose spraying direction and the flywheel plane form the corner of Φ2.

20. The nuclear reactor of claim 12, wherein the cylinder is pushing cylinder (36), whose spraying direction and the flywheel plane form the corner of Φ2.

21. The nuclear reactor of claim 13, wherein the cylinder is pushing cylinder (36), whose spraying direction and the flywheel plane form the corner of Φ2.
